(19) United States
(12) Patent Application Publication
(10) Pub. No.: US 2004/0156945 A1
(43) Pub. Date: Aug. 12, 2004

(54) Injection mold, molding system having injection mold, method thereof and molded product

(76) Inventors: Jae-Dong Yoon, Gyeonggi-Do (KR); Soon-Kug Hong, Gyeonggi-Do (KR); Ji-Hyun Kim, Suwon (KR)

Correspondence Address: BIRCH STEWART KOLASCH & BIRCH, PO BOX 747, FALLS CHURCH, VA, 22040-0747, US

(21) Appl. No.: 10/772,315

(22) Filed: Feb. 6, 2004

(30) Foreign Application Priority Data
Feb. 10, 2003 (KR) 10-2003-0008131
Mar. 11, 2003 (KR) 10-2003-0015101

(51) Int. Cl. B29C 45/04

(52) U.S. Cl. 425/575

(57) ABSTRACT

An injection mold includes: a fixed mold having a passage for introducing a fluid therethrough and an internal space; a movable mold detachably attached to the fixed mold and forming a molding space together with the internal space of the fixed mold; and a flow accelerating means provided on an inner wall of the molding space and accelerating flow of the fluid. A molding system having the injection mold, a molded product by the molding system and its molding method are also disclosed. Since a glossy surface is formed at the outer surface of a plastic product, a molded product, without a weld line or a gas flow mark, the external appearance is fine and the mechanical strength is enhanced. In addition, since no surface processing equipment or process is required to make the external appearance of the plastic product fine, the structure can be simplified, a stability can be heightened, a cost for installation of equipment can be reduced, and a fabrication process can be reduced.

### BACKGROUND OF THE INVENTION

1. Field of the Invention

The present invention relates to an injection mold and, more particularly, to an injection mold capable of making external appearance of a certain shape molded with a mold material fine, maintaining a high mechanical strength, simplifying a structure, reducing a fabrication process and enhancing a stability, a molding system having the injection mold, its method and a molded product.

2. Description of the Background Art

According to a general plastic molding technique, plastic granules, that is, pellets, produced in a chemical factory, are melt by electric heat or mechanical frictional heat, which is then injected into a mold to fabricate a desired shaped plastic product.

In such a plastic molding technique, because a ratio of a material accounts for very high in a cost for fabricating a plastic product, a foaming technique has been developed to reduce a quantity of material to be used.

The foaming technique is to make a plastic product have many foams with a fine size. In detail, a chemical or physical foaming agent is mixed with the pellets sufficiently, heat is applied from an external source to melt the foaming agent-pellet mixture, and then, the molten mixture is injected into the mold. As the foaming agent is injected together with the molten plastic into the mold, it is gasificated in the mold, so that foams are contained in the plastic product fabricated by the mold.

Such a plastic product fabricated according to the foaming technique includes many foams therein, so that a material cost can be considerably reduced, a weight of the product can be reduced, and an insulation performance can be enhanced.

Meanwhile, if the foaming agent is not uniformly mixed with the molten plastic or if big foams are partially formed, a mechanical strength such as an impact strength or a tenacity of the plastic product weakens much or less.

In addition, as the foaming agent, pentane or Freon is generally used. However, since such a foaming agent is detrimental to the environment, the current tendency limits its use.

In order to overcome such shortcomings, a ultra-fine foaming technique is under development. According to the ultra-fine foaming technique, a certain amount of gas is supplied to a molten plastic, and the molten plastic and gas are put in a mold so that foams can be formed in a plastic product according to a pressure difference. The plastic product fabricated according to the ultra-fine foaming technique can overcome the degradation of the mechanical strength which has been indicated as a limitation of the foaming technique because foams can be uniformly distributed in the product overall, each foam has a diameter of about scores of micrometer, and the number of foams per unit volume by the unit of centimeter is more than 10⁹.

FIG. 1 illustrates the ultra-fine foaming plastic molding apparatus.

As shown in FIG. 1, the ultra-fine foaming plastic molding apparatus includes: a cylinder 10 having an inlet 11 and an outlet 12; a hopper 20 mounted at the inlet 11 and supplying pellets, a plastic, into the cylinder 10; a gas supplier 30 for supplying a high pressure foaming gas into the cylinder 10; a screw 40 for rotatably installed inside the cylinder 10; a heater 50 for heating the pellets introduced in the cylinder 10; a fixed mold 60 having a certain space therein and connected to the outlet 12; and a movable mold 70 for detachably attached to the fixed mold 60 and forming a molding space (A) together with the internal space of the fixed mold 60.

Reference numeral 13 denotes a nozzle.

The ultra-fine foaming plastic molding apparatus constructed as described above operates as follows.

A certain quantity of pellets is introduced into the cylinder 10 through the hopper 20 and a certain quantity of foaming gas is injected into the cylinder 10 through the gas supplier 30. At the same time, the heater 50 operates to heat the interior of the cylinder 10 and the screw 40 rotates. The heater 50 heats the interior of the cylinder 10 so that the internal pressure and temperature of the cylinder 10 can be higher than a critical pressure and a critical temperature of the foaming gas in order to change the injected foaming gas to a supercritical fluid.

Inside the cylinder 10, the molten plastic and the foaming gas mixed in the molten plastic are injected into the molding space (A) formed by the fixed mold 60 and the movable mold 70 according to rotation of the screw 40.

The molten plastic injected into the molding space (A) is coagulated, and as the foaming gas is foamed due to a pressure difference in the molding space (A), foams are formed inside the coagulated plastic.

However, as for the plastic product fabricated through the above-described process, when the molten plastic is injected into the molding space (A) formed by the fixed mold 60 and the movable mold 70, the foaming gas is separated from the molten plastic and the molten plastic is immediately coagulated, rather than flowing sufficiently. Accordingly, as shown in FIG. 2, gas flow marks (B) are inevitably formed at an outer surface of the plastic product being in contact with the surface of the fixed mold 60 and the movable mold 70 each constituting inner walls of the molding space (A).

Since such gas flow marks degrade a fine view of the plastic product, the completed plastic product is subject to a surface processing to remove the gas flow marks.

The surface treatment includes a mold heating method, a mold gas injection method and a spray method.

With reference to FIG. 3, the mold heating method is that a heating unit 90 using LPG is provided at one side of a mold 80, by which one side of the mold 80 is continuously heated to continuously fabricate a plastic product 100 by the heated molds 82 and 83. In this method, however, in order to suitably mix air and LPG by the heating unit 100 heating the molds 82 and 83, a high-priced equipment is used and the method is dangerous because of LPG. In addition, since only one side of the completed plastic product 100 is heated, the plastic product 100 is deformed by being bent, for which a process is to be performed additionally, degrading a productivity.

In case of the spray method, a surface-processing material is sprayed onto the surface of the completed plastic product. This method is disadvantageous in that the operation is complicate and a fabrication cost increases.

In case of the mold gas injection method, a gas is injected into the mold, the mold is closed, and then, a time point for foaming is controlled. In this method, a gas pressure in the mold is so high that a quite high pressure is required for the injection molding. Thus, an equipment needs to be installed to handle the high pressure, causing a cost increase for installation of the equipment and a danger due to the high pressure.

### SUMMARY OF THE INVENTION

Therefore, one object of the present invention is to provide an injection mold capable of making external appearance of a certain shape molded with a molten material smooth and neat and maintaining a high mechanical strength, a molding system having the injection mold, its method, and a molded product.

Another object of the present invention is to provide an injection mold capable of simplifying a structure of an equipment for fabricating a molded product, reducing fabrication processes, and enhancing a stability, a molding system, its method, and a molded product.

To achieve these and other advantages and in accordance with the purpose of the present invention, as embodied and broadly described herein, there is provided an injection mold including: a fixed mold having a passage for introducing a fluid therethrough and an internal space; a movable mold detachably attached to the fixed mold and forming a molding space together with the internal space of the fixed mold; and a flow accelerating means provided on an inner wall of the molding space and accelerating flow of the fluid.

To achieve the above objects, there is also provided a molding system including: a cylinder having an inlet and an outlet; a screw installed inside the cylinder and making a mold material including a plastic introduced into the inlet of the cylinder flow toward the outlet; a heater for heating the mold material introduced in the cylinder; a fixed mold having a certain space therein and connected to the outlet of the cylinder; a movable mold detachably coupled to the fixed mold and forming a molding space together with the internal space of the fixed mold; and a flow accelerating means provided on an inner wall of the molding space and accelerating flow of a fluid.

To achieve the above objects, there is also provided a molding method including: coating a coating material for accelerating flow of a fluid on an inner wall of a molding space formed in an injection mold; mixing a mold material, a foaming agent and a gas and heating the mixture to above a pre-set temperature; and injecting the molten mixture into the molding space of the injection mold.

To achieve the above objects, there is also provided a molded product with a glossy surface at the overall external appearance, including a surface layer having a prescribed thickness starting from the glossy surface into the interior and having no foams, and a deep layer having a plurality of fine foams under the surface layer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing one example of a general plastic molding apparatus;

FIG. 2 is a plane view showing a surface state of a plastic product molded by the plastic molding apparatus;

FIG. 3 is a sectional view showing another example of a general plastic molding apparatus;

FIG. 4 is a sectional view showing an injection mold in accordance with the present invention;

FIG. 5 is a sectional view showing a fixed mold constituting the injection mold;

FIG. 6 is a sectional view showing a molding system having the injection mold in accordance with the present invention;

FIG. 7 is a flow chart of a molding method in accordance with the present invention;

FIG. 8 is a sectional view showing a portion of a molded product in accordance with the present invention; and

FIG. 9 is a table showing comparison between the present invention and conventional arts.

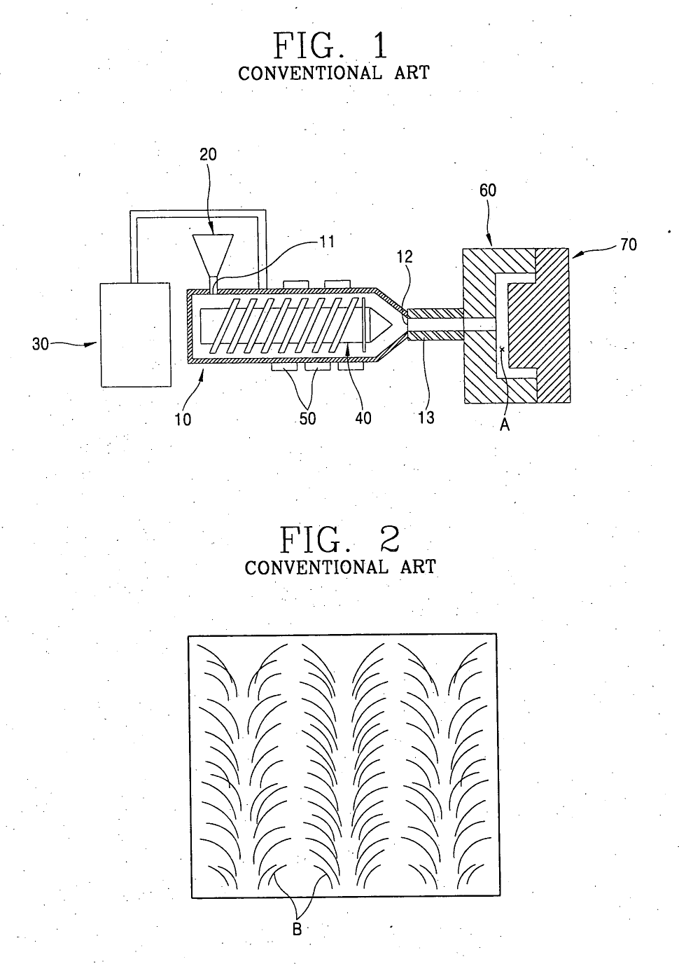

### DETAILED DESCRIPTION OF THE PREFERRED EMBODIMENTS

An injection mold, a molding system having the injection mold, its method and a molded product in accordance with a preferred embodiment of the present invention will now be described with reference to the accompanying drawings.

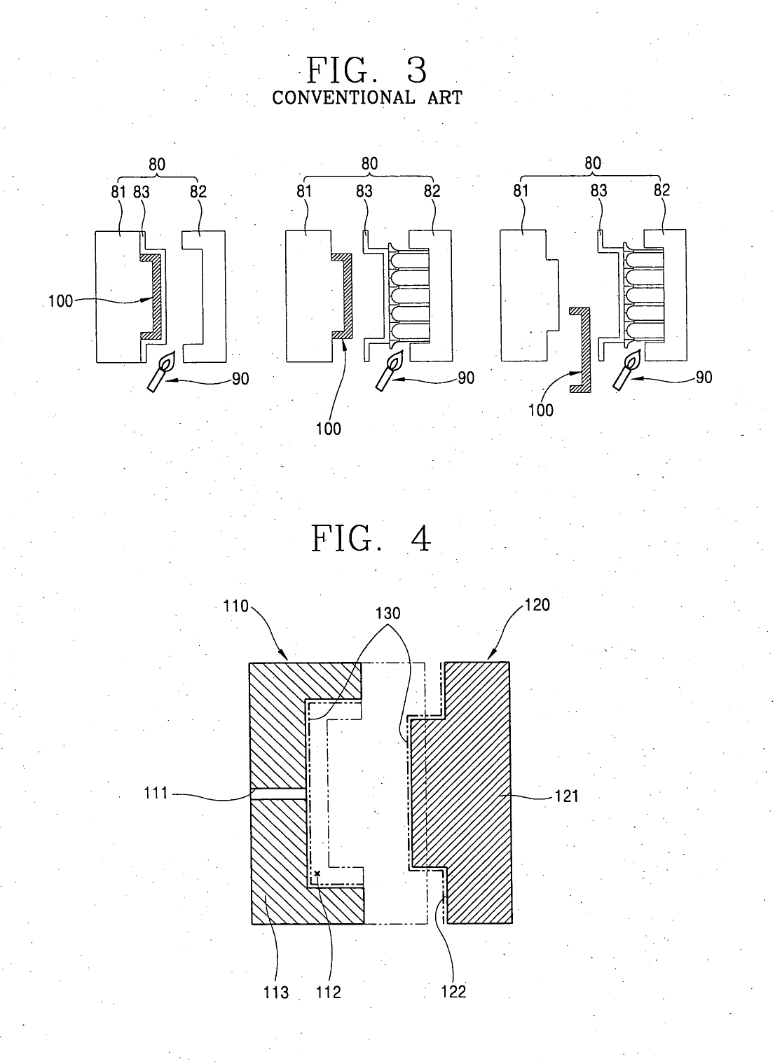

FIG. 4 is a sectional view showing an injection mold in accordance with the present invention.

As shown in FIG. 4, the injection mold includes a fixed mold 110 having a passage 111 for introducing a fluid therethrough and an internal space 112; a movable mold 120 detachably coupled to the fixed mold 110 and forming a molding space together with the internal space 112 of the fixed mold 110; and a flow accelerating means 130 provided at the inner wall of the molding space and accelerating flowing of the fluid.

The fixed mold 110 includes a body part 113 with a certain shape, the internal space 112 formed inside the body part 113; and the passage 111 formed in the body part 113 and communicating with the internal space 112.

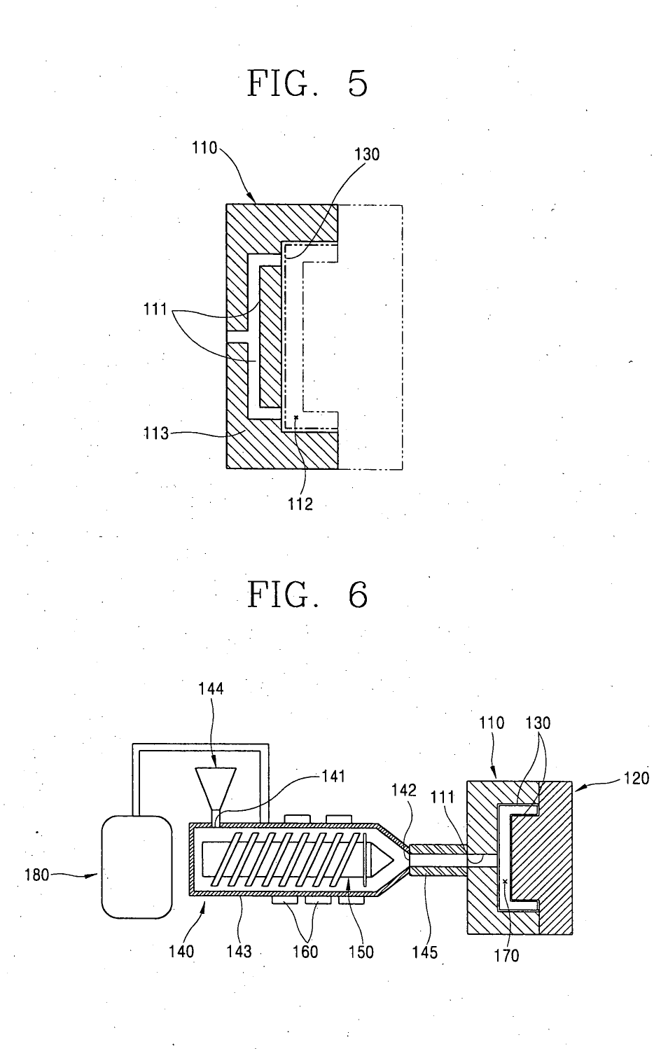

The internal space 112 can have various forms, and one side thereof is opened. As for the passage, as shown in FIG. 5, two passages can be formed according to a shape and a size of a molded product. The passage 111 can have various forms.

The movable mold 120 includes a body part 121 with a certain shape and a molded-surface part 122 protruded from the body part 121 or possibly including a concave portion in order to form a molding space together with the internal space 112 of the fixed mold. The molded-surface part 122 can have various forms.

The flow accelerating means 130 is a solid coating material, which increases insulation characteristics and reduces a flow resistance of a fluid. The solid coating material is coated on the inner wall of the internal space 112 of the fixed mold 110 and the molded-surface part 122 of the movable mold. The flow accelerating means can be also formed on the inner wall of the passage 111 of the fixed mold 110.

Preferably, the solid coating material is one of a polymer coating material, a ceramic coating material, a solid lubricant and a solid metal.

As the polymer coating material, PEEK (Poly Ether Ether Ketone) is preferably used. In addition, PTFE (Polytetrafluorothylene), PE (Polyethylene), methacrylates or the like can be also used.

As the ceramic coating material, aluminum oxide, zirconium oxide or the like can be used.

As the solid lubricant, graphite, molybdenum, disulfide or the like can be used.

As the solid metal, lead, indium, cadmium, tin, silver or the like can be used.

FIG. 6 is a sectional view showing a molding system having the injection mold in accordance with the present invention.

As shown in FIG. 6, a molding system having the injection mold includes: a cylinder 140 having an inlet 141 and an outlet 142; a screw 150 installed inside the cylinder 140 and making a mold material and a mixture containing a plastic introduced into the inlet 141 of the cylinder flow toward the outlet 142; a heater 160 for heating the mold material and the mixture introduced in the cylinder 140; a fixed mold 110 for forming an internal space 112 with a certain shape and a passage 111 therein and connected to the outlet 142 of the cylinder; a movable mold 120 detachably coupled to the fixed mold 110 and forming a molding space 170 together with the internal space 112 of the fixed mold; and a flow accelerating means 130 provided on the inner wall of the molding space 170 and accelerating flowing of a fluid.

The cylinder 140 includes a hermetic cylindrical part 143 having prescribed inner diameter and length; the inlet 141 formed at a side of the cylindrical part 143; and the outlet 142 formed at one end of the cylindrical part 143. A hopper 144 is installed at the inlet 141 of the cylinder to facilitate injection of a mold material into the inlet 141.

The screw 150 is rotatably installed in the cylindrical part 143 of the cylinder, and the heater 160 is provided at the cylindrical part 143 of the cylinder.

The fixed mold 110 and the movable mold 120 constitute the injection mold, which has been described above.

Namely, the fixed mold 110 includes the body part 113 with a certain shape, the internal space 112 formed inside the body part 113, and the passage 111 formed in the body part 113 and communicating with the internal space.

The internal space 112 can have various forms, and its one side is opened. As for the passage 111, one passage is formed, or two passages can be formed according to a shape of a size of a molded product.

The movable mold 120 includes the body part 121 with a certain shape and the molded-surface part 122 protruded from the body part 121 or including a concave portion in order to form a molding space together with the internal space 112 of the fixed mold. The molded-surface part 122 can have various forms.

The fixed mold 110 is connected to the outlet 142 of the cylinder by a nozzle 145 coupled to the outlet 142 of the cylinder. The nozzle 145 is connected to the passage 111 of the fixed mold.

The flow accelerating means 130 is a solid coating material, which increases insulation characteristics and reduces a flow resistance of a fluid. The solid coating material is coated on the inner wall of the internal space 112 of the fixed mold 110 and the molded-surface part 122 of the movable mold. The flow accelerating means can be also formed on the inner wall of the passage 111 of the fixed mold 110.

A foaming agent supplier 180 is provided at the side of the inlet 141 of the cylinder in order to supply a foaming agent into the cylinder 140. The foaming agent supplier 180 is a generally used known art.

In case that a gas is injected into the cylinder 140, a gas supplier is provided to supply the gas to the cylinder 140. The gas supplier is also a generally used known art.

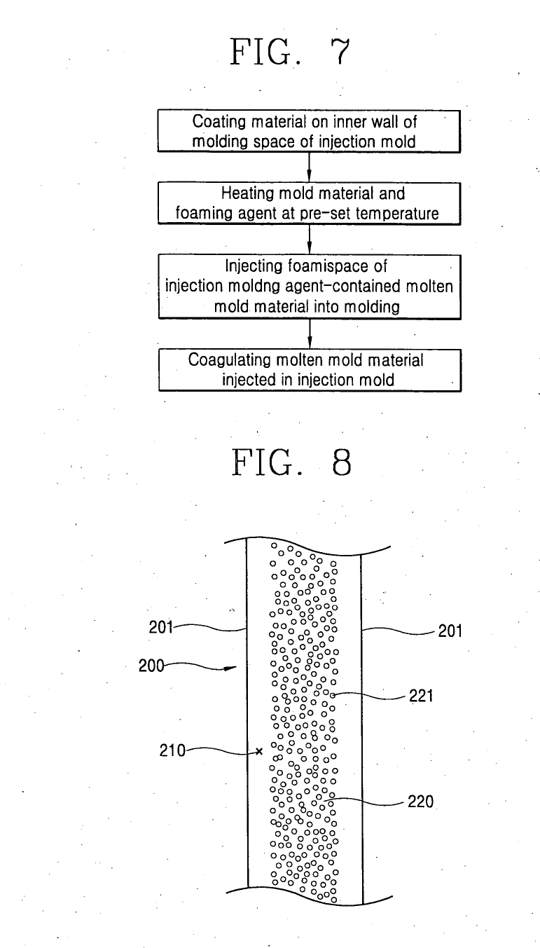

FIG. 7 is a flow chart of a molding method in accordance with the present invention.

As shown in FIG. 7, the molding method of the present invention includes: a first step of coating a coating material for accelerating flow of a fluid on an inner wall of a molding space 170 provided in an injection mold; a second step of mixing a mold material, a foaming agent and a gas and heating the mixture to above a pre-set temperature; and a third step of injecting the molten mixture into the molding space 170 of the injection mold.

As afore-mentioned, the injection mold includes the fixing side mole 110 and the movable mold 120, and the molding space 170 formed by the fixed mold 110 and the movable mold 120 can have various forms. In addition, the injection mold can be implemented in various formed besides the fixed mold 110 and the movable mold 120.

The coating material is a solid coating material as described above.

In the second step, the mixture can comprises the mold material and the foaming agent or comprises the mold material and the gas supplied by the gas supplier. The mold material is a pellet, that is, plastic, and can be a different material.

In case that the mixture includes the pellet and the foaming agent or includes the pellet and the gas, a heating temperature should be so high that the pellet can be changed to a molten plastic and the foaming agent or the gas can be changed into a supercritical state. As the foaming agent or the gas, which has been heated to the supercritical state, is injected together with molten plastic into the molding space 170 of the injection mold, fine foams are formed in a plastic product as being completely molded by the injection mold.

FIG. 8 is a sectional view showing a portion of a molded product in accordance with the present invention.

As shown in FIG. 8, a molded product 200 includes a surface layer 210 having a glossy outer surface 201 and a deep layer 220 formed at the inner side of the surface layer 210 and having a plurality of fine foams 221 therein.

An outer side of the plastic product, the molding produce 200 fabricated by the injection mold, forms the surface layer 210 and the deep layer 220 is formed at the inner side of the surface layer 210.

Foams 221 are not formed in the surface layer 210, and the outer surface of the surface layer 210 forms the glossy surface 201. The surface layer 210 has a thickness of 0.01 mm˜10 mm and accounts for less than 50% of the overall volume of the molded product 200. Preferably, the foam 221 has a diameter of 0.1 μm˜1000 μm.

The operation and effect of the injection mold, the molding system having the injection mold, its method and the molded product will now be described.

First, the molding system having the injection mold operates as follows.

A pellet, a mold material, is injected into the cylinder 140 through the inlet 141 of the cylinder, and a certain quantity of foaming gas is also injected into the cylinder 140 through the gas supplier. At the same time, the heater 160 is operated to heat the interior of the cylinder 140 and the screw 150 is rotated.

The heater 160 heats the interior of the cylinder 140 at a higher temperature and pressure than a critical pressure and a critical temperature of the foaming gas so that the injected foaming gas can be changed into a supercritical fluid.

The plastic molten in the cylinder 140 and the foaming gas mixed in the molten plastic are introduced into the molding space 170 formed by the fixed mold 110 and the movable mold 120 through the passage 111 of the fixed mold according to rotation of the screw 150.

In the process that the molten plastic is introduced into the molding space 170 through the passage 111 of the injection mold, the solid coating material, that is, the flow accelerating means 130, provided on the inner wall of the molding space 170 accelerates flowing of the molten plastic.

In other words, the solid coating material coated on the inner wall of the molding space 170 serves as a lubricant between the inner wall of the molding space 170 and the molten plastic to reduce a friction therebetween, and insulates the molding space 170. Accordingly, a quick coagulation of the molten plastic can be restrained and its flowing can be accelerated.

Therefore, since flowing of the molten plastic is accelerated inside the molding space 170 of the injection mold, the molten plastic can be introduced even to a corner portion of the molding space 170 and sufficiently coagulated and mixed with a molten plastic introduced into the molding space 170 through a different passage. Thus, a weld line, generated between molten plastics as they fail to be smoothly mixed and coagulated after being introduced from different passages, can be prevented.

In addition, since the molten plastic introduced into the molding space 170 is accelerated in its flowing thanks to the insulation and reduction of the frictional resistance by the solid coating material, the flow accelerating means, a gas flow mark, which is generated as the molten plastic is immediately coagulated on the inner wall of the molding space 170, can be prevented.

Namely, the foams foamed from the inner wall of the molding space 170 do not remain on the inner wall of the molding space 170 and moved inwardly, so that they are positioned inside the plastic product completed after the molten plastic is coagulated, and the surface of the plastic product is formed as a glossy surface without an foam.

In case that the pellet, the mold material, and the foaming agent are injected into the cylinder 140, a plastic product is fabricated through the same process as described above.

In the injection mold and the molding method of the present invention, the molten plastic and the foaming agent or the molten plastic and the gas are introduced into the molding space 170 of the injection mold through the passage 111, and accelerated in its flowing in the molding space thanks to the insulation and reduced frictional resistance by virtue of the flow accelerating unit 130 provided on the inner wall of the molding space 170. Accordingly, the molten plastic can be evenly filled in the molding space 170 and formation of the weld line can be prevented.

In addition, since the flowing of the molten plastic is accelerated by the flow accelerating means 130 provided on the inner wall of the molding space 170 of the injection mold, foams foamed inside the molding space 170 move inwardly, rather than remaining on the inner wall of the molding space 170, so that the surface of the plastic product completed after coagulation of the molten plastic is formed as the glossy surface 201 and foams 221 are formed inside the plastic product.

The solid coating material used as the flow accelerating means 130 effectively insulates the molding space 170 of the injection mold and effectively reduces a friction between the inner wall of the molding space 170 and the molten plastic.

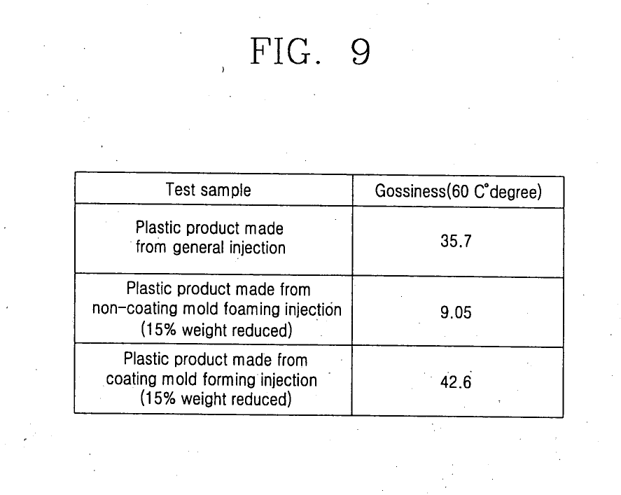

FIG. 9 is a table comparatively showing glossiness of a plastic product molded by a general injection, a plastic product molded by the foaming injection and a plastic product molded according to the present invention. Herein, among the solid coating materials, the PTFE (polytetrafluorothylene) coating is applied as the flow accelerating means 130, and a test sample has a width of 50 mm and length of 60 mm and thickness of 1.5 mm, and is made of ABS resin.

As shown in FIG. 9, the surface glossiness of the plastic product in accordance with the present invention is higher than those fabricated according to the conventional arts.

The molded product 200 of the present invention includes the surface layer 210 and the deep layer 220 and the entire surface layer 210 is formed as the glossy surface 201, so that the outer appearance is clean and elegant. In addition, since the fine foams 221 are formed in the deep layer 220, the amount of material to be used can be reduced and a weight can be also reduced while maintaining its mechanical strength.

As so far described, the injection mold, the molding system having the injection mold, its method and the molded product of the present invention have the following advantages.

That is, for example, since the glossy surface is formed at the outer surface of a plastic product, a molded product, without a weld line or a gas flow mark, the external appearance is fine and the mechanical strength is enhanced, and thus, buying power of users and a reliability can be heightened.

In addition, since no surface processing equipment or process is required to make the external appearance of the plastic product fine, the structure can be simplified, stability can be heightened, a cost for installation of equipment can be reduced, and a fabrication process can be reduced. Thus, productivity can be enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An injection mold comprising:
a fixed mold having a passage for introducing a fluid therethrough and an internal space;
a movable mold detachably attached to the fixed mold and forming a molding space together with the internal space of the fixed mold; and
a flow accelerating means provided on an inner wall of the molding space and accelerating flow of the fluid.

2. The mold of claim 1, wherein the flow accelerating means is a solid coating material for increasing insulation of the fluid and reducing a flow resistance of the fluid.

3. The mold of claim 2, wherein the solid coating material is a polymer coating material.

4. The mold of claim 3, wherein the polymer used for the polymer coating material is PEEK (Poly Ether Ether Ketone).

5. The mold of claim 3, wherein the polymer coating material is one of PTFE (Polytetrafluorothylene), PE (Polyethylene) and methacrylates.

6. The mold of claim 2, wherein the solid coating material is a ceramic coating material.

7. The mold of claim 6, wherein the ceramic coating material is one of aluminum oxide and zirconium oxide.

8. The mold of claim 2, wherein the solid coating material is a solid lubricant.

9. The mold of claim 8, wherein the solid lubricant is one of graphite, molybdenum and disulfide.

10. The mold of claim 2, wherein the solid coating material is a solid metal.

11. The mold of claim 10, wherein the solid metal is one of lead, indium, cadmium, tin and silver.

12. A molding system comprising:
a cylinder having an inlet and an outlet;
a screw installed inside the cylinder and making a mold material and a mixture including a plastic introduced into the inlet of the cylinder flow toward the outlet;
a heater for heating the mold material and mixture introduced in the cylinder;
a fixed mold having a certain space therein and connected to the outlet of the cylinder;
a movable mold detachably coupled to the fixed mold and forming a molding space together with the internal space of the fixed mold; and
a flow accelerating means provided on an inner wall of the molding space and accelerating flow of a fluid.

13. The system of claim 12, wherein a foaming agent supplier is provided at the side of the inlet of the cylinder to supply a foaming agent into the cylinder.

14. The system of claim 12, wherein a gas supplier is provided at the side of the inlet of the cylinder to supply a gas into the cylinder.

15. The system of claim 12, wherein the flow accelerating means is a solid coating material for increasing insulation of the fluid and reducing a flow resistance of the fluid.

16. A molding method comprising:
coating a coating material for accelerating flow of a fluid on an inner wall of a molding space formed in an injection mold;
mixing a mold material and a foaming agent(or a gas) and heating the mixture to above a pre-set temperature; and
injecting the molten mixture into the molding space of the injection mold.

17. The method of claim 16, wherein the solid coating material is a polymer coating material.

18. The method of claim 17, wherein the polymer coating material is one of PEEK(Poly Ether Ether Ketone), PTFE (Polytetrafluorothylene), PE (Polyethylene) and methacrylates.

19. A molded product comprising:
a surface layer formed as a glossy surface at the overall external surface and having a non-foam layer with a prescribed thickness starting from the glossy surface into the interior; and
a deep layer having a plurality of fine foams under the surface layer.

20. The product of claim 19, wherein the surface layer accounts for less than 50% of the overall volume formed by the external surface.

21. The product of claim 19, wherein a thickness of the surface layer 0.01 mm˜10 mm.

22. The product of claim 19, wherein a diameter of the foam is 0.1 μm˜1000 μm.
